(19) United States
(12) Patent Application Publication
(10) Pub. No.: US 2006/0073784 A1
(43) Pub. Date: Apr. 6, 2006

(54) Air displacement upon a medical patient

(76) Inventor: Terrel Porter, Weston, ID (US)

Correspondence Address: Lynn G. Foster, 602 East 300 South, Salt Lake City, UT, 84102, US

(21) Appl. No.: 10/950,142

(22) Filed: Sep. 25, 2004

(51) Int. Cl. B01L 1/04

(52) U.S. Cl. 454/187

(57) ABSTRACT

Methods and Apparatus are disclosed by which a stream of air, under the facile control of the patient, is created and directly impinged upon a selected body located through a yieldable discharge tube of variable length to improve patient comfort. The direction of the stream may be readily changed from time-to-time by the patient, above or below the bed covers. The temperature of the stream may be ambient, above ambient and below ambient, as desired. The air flow generator is completely safe, even when placed on the bed contiguous with the patient.

### FIELD OF INVENTION

The present invention relates generally to increasing the comfort level of a bed-ridden medical patient and, more particular, to providing a mechanism, and related methods, by which a stream of air is created and impinged upon a selected body location of the patient.

### BACKGROUND

Traditionally, a medical patient's comfort level, when bed-ridden, is improved by placing a conventional fan near but spaced from the bed occupied by the patient. Such fans deliver a stream of air across the bed, either in a single direction, where the fan is fixed in position, or across the sweep of the fan, where the fan oscillates.

Adjustments by the patient to such off-bed fans sometimes is difficult because of the limitations or incapacitations of the patient. At other times, the fan-derived air is poorly directed or leaves the patient uncomfortable or inadequately served. Off-bed fans require the patient to either remove bed covers in whole or in part, or direct the flow of air upon the bed covers, rather than upon the patient.

While most of the time ambient air best serves the patient's needs, sometimes heated or cooled air is preferred.

### BRIEF SUMMARY AND OBJECTS OF THE INVENTION

In brief summary, the present invention overcomes or substantially alleviates problems of the past in the field of medical patient comfort. Methods and Apparatus are provided by which a stream of air, under the facile control of the patient, is created and directly impinged upon a selected body location to improve patient comfort. The direction of the stream may be readily changed from time-to-time by the patient, above or below the bed covers. The temperature of the stream may be ambient, above ambient and below ambient, as desired. The air flow generator is completely safe, even when placed on the bed contiguous with the patient.

With the foregoing in mind, it is a primary object of the present inventor to provide novel methods and apparatus which overcome or substantially alleviate problems of the past in the field of medical patient comfort.

It is a further valuable object to provide novel methods and apparatus by which a stream of air, under the facile control of a bed-ridden patient, is created and directly impinged upon a selected body location to improve patient comfort.

It is another important object to provide novel methods and apparatus by which stream of air cam be selectively redirected from time-to-time upon a bed-ridden patient by patient adjustment, to different body locations, above or below the bed covers, to increase patient comfort.

Another powerful object is the provision of novel methods and apparatus for directing upon a medical patient a machine created stream of air at ambient, above ambient or below ambient temperature.

Another significant object is the provision of novel methods and apparatus for impinging a stream of air on a bed-ridden medical patient, which are completely safe, even when the apparatus is on the bed contiguous with the patient.

These and other objects and features of the present invention will be apparent from the detailed description taken with reference to the accompanying drawings.

### BRIEF DESCRIPTION OF THE DRAWINGS

FIG. 1 is a diagrammatic illustration of one form of the present invention;

FIG. 2 is an assembled perspective of a form of the present invention similar to FIG. 1;

FIG. 3 in an exploded perspective of the embodiment of FIG. 1;

FIG. 4 is an elevation taken along lines 4-4 of FIG. 3;

FIG. 5 is a fragmentary cross section taken along lines 5-5 of FIG. 3;

FIG. 6 is a cross section taken along lines 6-6 of FIG. 3;

FIG. 7 is a fragmentary cross section taken along lines 7-7 of FIG. 3;

FIG. 8 is a perspective of the discharge tube of FIG. 3 arranged in one of many configurations; and

FIG. 9 is a perspective of a bed-ridden medical patient making use of the methods and apparatus of the present invention.

### DETAILED DESCRIPTION OF THE ILLUSTRATED EMBODIMENTS

Traditionally, a medical patient's comfort level, when bed-ridden, is improved by placing a conventional fan near but spaced from the bed occupied by the patient. Such fans deliver a stream of air across the bed, either in a single direction, where the fan is fixed in position, or across the sweep of the fan, where the fan oscillates.

Adjustments by the patients to such off-bed fans sometimes is difficult, because of the limitations and incapacities of the patient. At other times, the fan-derived air is poorly directed or leaves the patient uncomfortable or inadequately served. Off-bed fans require the patient to either remove bed covers, such as sheets and blankets, in whole or in part, in order to direct the flow of air upon the bed covers, rather than upon the patient. While ambient air may serve the best interest of the patient, sometimes heated or cooled air is preferred, but such is not available from standard bed side fans.

The present invention overcomes or substantially alleviates the above-mentioned problems of the past in the field of the comfort afforded to a bed-ridden medical patient. Using the novel methods and apparatus of the present invention, a stream of air, under the facile control of the patient, is created, usually on the bed itself, and impinged upon a selected body location to improve patient comfort. The direction of the stream may be readily changed from time-to-time by the patient and the temperature of the stream may be ambient, above ambient or below ambient, at any given point in time, as desired. The air flow generator is completely safe, even when placed on the bed contiguous with the patient.

Reference is now made to the drawings, wherein like numerals are used throughout to designate like parts.

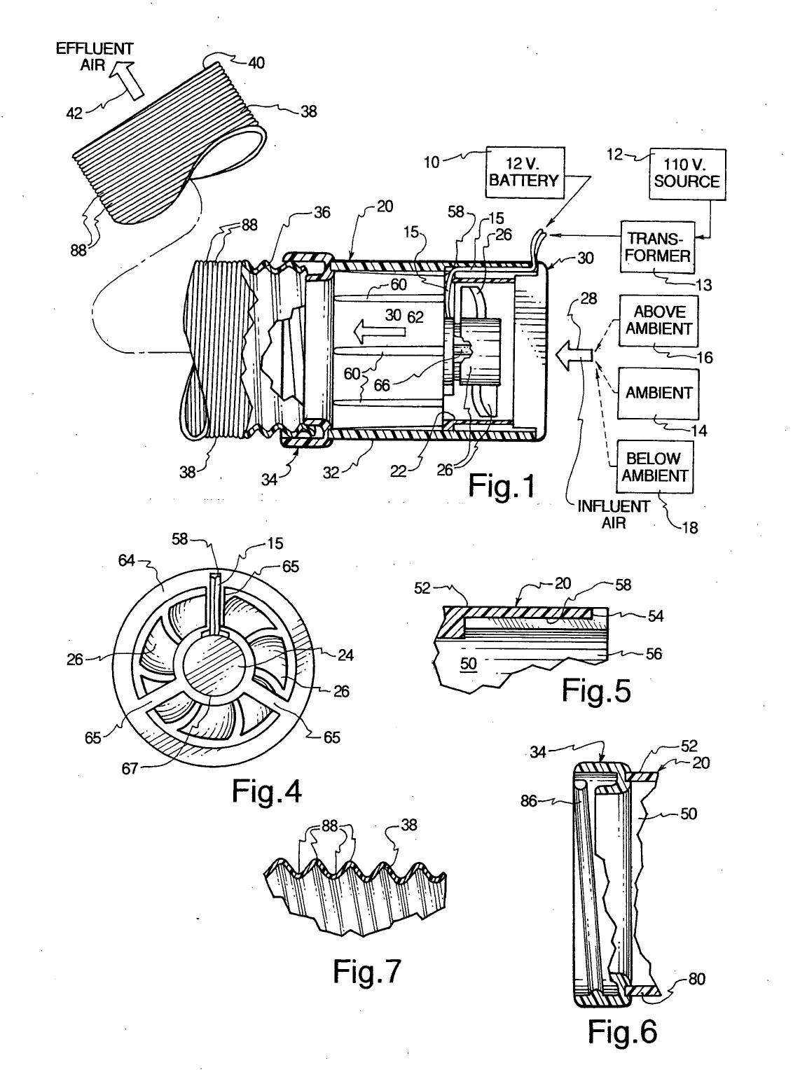

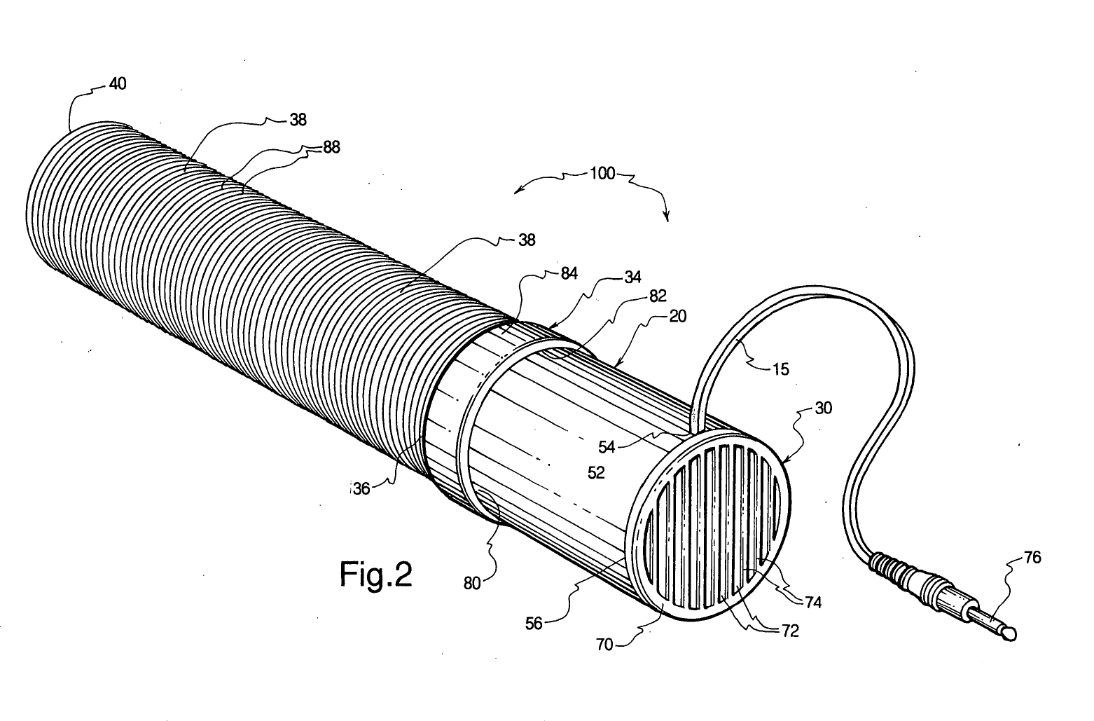

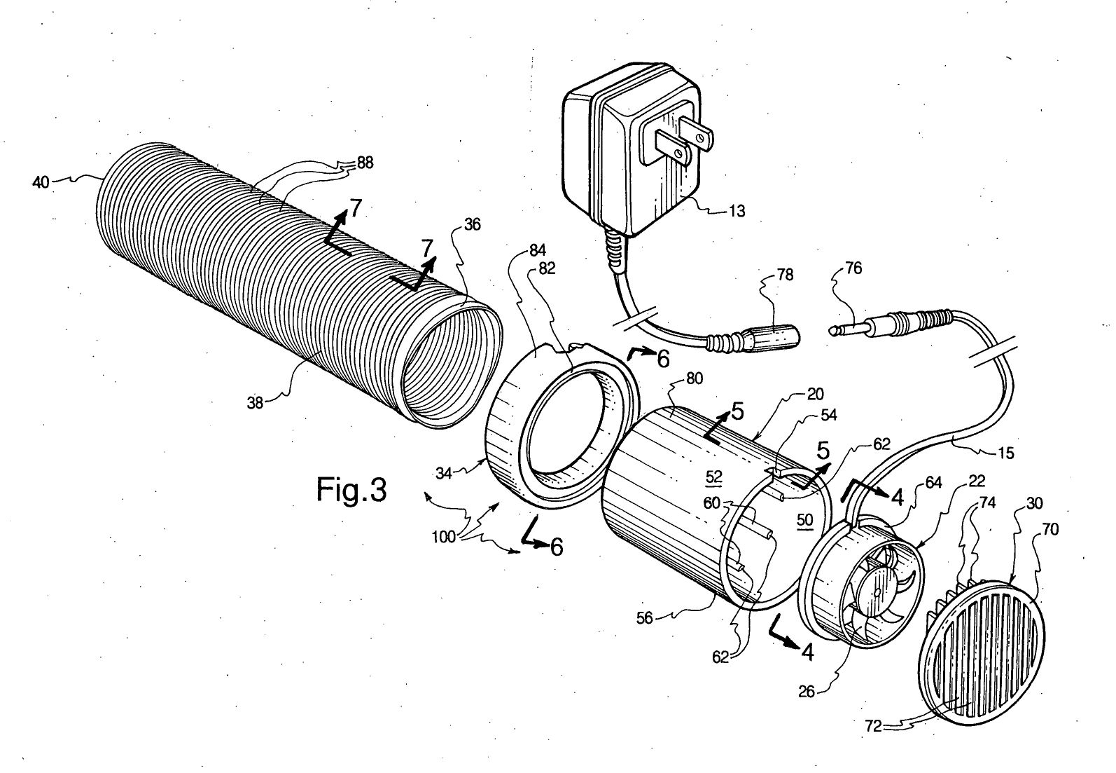

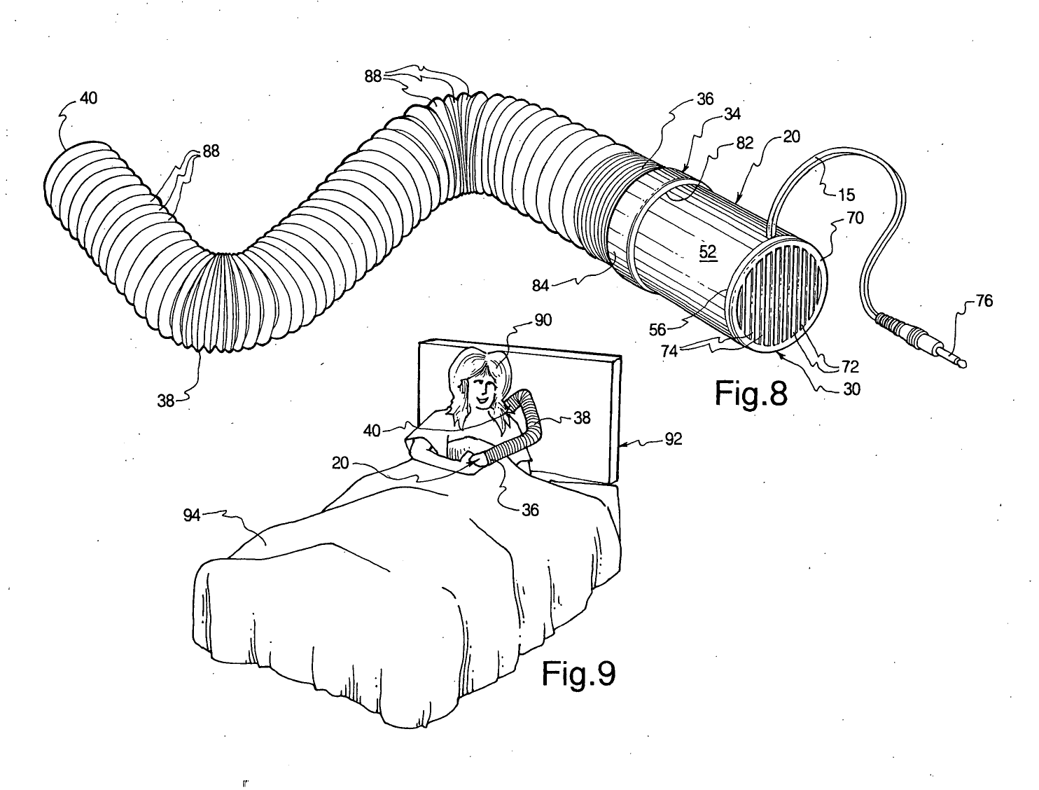

One embodiment of the present invention is diagrammatically illustrated in FIG. 1 and comprises a plurality of elements, namely, a source of power 10, 12, sources of ambient, above ambient and below ambient air 14, 16, and 18, a cylindrical housing 20, formed of shape-retaining synthetic resinous material, generally in the shape of a hollow tube, an annular sheath 22 in which an electric motor 24 and a low voltage fan 26 are securely disposed. Influent air 28 is displaced through an intake louvered proximal end cap 30 through spaced blades of the fan 26 emerging as an internally contained stream of air 30 at the distal end of the housing 20. The distal end 32 of the housing 20 connects to a hollow end cap 34. A proximal end 36 of a yieldable and extendable/contractible discharge tube 38 is releasibly connected to the distal end of the collar 34. The extendable, contractible, reconfigurable discharge tube 38 comprises a discharge end 40 from which effluent air 42 issues and is impinged as a stream upon a selected area of the body of a patient.

Above ambient air 16 may be derived from any type of suitable commercially available heater, while air below ambient temperature at 18 may be cooled using evaporative cooling or refrigeration. Ambient air 14 may simply be obtained directly from the room in which the medical patient 90 is bed-ridden at 92. FIG. 9.

In the embodiment illustrated in FIG. 1, the electric motor 24 is illustrated as a twelve volt motor which is rotated by twelve volt electricity whether from battery 10 or from a one hundred ten volt source transformed into twelve volt energy utilizing a conventional transformer 13.

With reference to FIGS. 2 and 3, the housing 20 comprises an annular layer formed of synthetic resinous material having a uniform thickness. The layer comprises an internal surface 50 of uniform diameter, an external surface 52 illustrated as being of uniform diameter, a radial slot 54 at proximal end 56 of the housing 20, through which sheath conductors 15 pass to supply low voltage electrical power to the motor 24. A groove 58 (FIG. 5) receives the sheathed conductors 15 to contain the same within the walls of the cylindrical housing 20 for the length of the groove 58.

A plurality of axially-directed internal ribs 60 comprising blunt proximal ends 62 are integrally formed on the interior surface 50 such that the blunt ends 62 collectively act as stops for the engaging annular flange 64 of the sheath 22. The blunt ends 62 are within a common radial plane so that when the flange 64 is inserted snugly within the hollow interior of the cylindrical housing 22 and displaced from the proximal toward the distal, the leading surface of the flange 64 will place the flange 64 in a radial plane. This causes the drive shaft 66 (FIG. 1), between the motor 24 and the fan 26, to be aligned coaxial with the axis of the housing 20. Thus, eccentricities are avoided.

The sheath 22, with the motor 24 and the fan 26 securely supported therein is held in the inserted position with the distal flange 64 contiguous with the abutment stop surfaces 62 by engagement between the enlarged distal end of the porous louvered cap 30 and the proximal end of the sheath 22. The motor 24 is illustrated as being snugly held in a stationary position within an internal support ring 67 rigidly connected to the enlarged flange 64 by three radial spokes 65.

It is presently preferred that the cap 30 be bonded or glued to the housing 20. Thus, the sheath 22, the flange 64, the motor 24 and the fan 26, as an assembly, are held snugly and immovably in their respective positions within the housing 20.

The end cap 30 comprises an annular ring 70, the outside diameter of which is shown to be substantially identical to the outside diameter of surface 52. The ring 70 is interrupted by a plurality of spaced parallel open slots 72, with spaced louvers 74, integral with the ring 70 defining the slot openings 72.

The openings 72 accommodate entry of influent air 28 (FIG. 1) into the air flow generator, generally designated 100, and shown in FIGS. 2 and 3.

While the delivery of low voltage electrical power through the sheath conductors 15 is conventional, embodiment of FIG. 3 illustrates use of a male and female coupler 76 and 78 along with transformer 13. Transformer 13 is illustrated as showing two exposed male prongs spaced and shaped for placement into a 110 volt wall plug for delivering 110 volt power to the transformer 13 from which 12 volt power is obtained for driving the motor by which influent air 28 is displaced into the generator 100 and effluent air 42 as a stream, issuing from the generator, impinges as desired upon the patient. The air 30 from the fan 26 exits the housing 20 and passes through the hollow coupler 34 into the hollow interior of the discharge tube 38. The tube 38 can be manipulated and repositioned so as to be extended, contracted and placed into whatever position is desired by the user, in order that the effluent air 42 issuing as a stream from the distal end 40 of the tube 38 is directed upon the patient's body one or more desired locations to provide improved patient comfort. Tube 38 may comprise a commercially available product known as Flexible Air Hose, manufactured by Taishan Zheng Yuan Plastic Product Co., Ltd., located in Guang Dong, China.

The annular distal end 80 of the cylindrical housing 20 is force-fit within a U-shaped groove 82 of the hollow distal fitting 34 in a snug closely fit relationship and it retained in that assembled condition by utilization of a suitable bonding agent or adhesive. The annular groove 82 in which the proximal end 80 is fitted is axially exposed, prior to assembly, only at the proximal end of the collar 34. At the interior of the distal end 84 of collar 34 comprises a partial helical thread 86, sized for connection to the corrogated proximal end 36 of the expandable, contractable distortable discharge tube 38.

The expansion and contraction of the discharge tube 38 is accommodated by a plurality of pleats 88 comprising the wall of the tube 58. The pleats 88 accommodate placing the discharge tube 38 in any one of many non-linear positions, such as those illustrated in FIGS. 1, 8 and 9. The discharge tube 38 allows the patient 90 (FIG. 9) confined to bed 92 to reconfigure the discharge tube so that the stream of air 42 issuing from the distal end thereof is directed exactly as the patient desires, either above or below the bed clothing 94.

The proximal end 36 of the discharge tube 38 is configured so as to dimensionally snugly engage the partial helical thread 86 as the discharge tube 38 is rotated in a first direction to releasibly connect the tube 38 and the collar 34. By rotating the tube 38 in the opposite direction, the tube 38 may be unthreaded from the collar 34 when and as desired.

The fan 26 is illustrated as comprising a plurality of radially-directed blades. These blades are preferably formed of deflectable synthetic resinous material to avoid injury. The rate of speed is correlated to the size of the electric motor 24. Accordingly, the size of the fan and the size of the motor may be varied, as desired by those skilled in the art in order that the amount and force of the effluent air 42 best accommodates the needs and comfort of the patient 90.

The invention may be embodied in other specific forms without departing from the spirit of the central characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A method by which a bedridden medical patient self-applies a stream of air directly to any desired body location, comprising the acts of:
creating influent air flow at and through a housing hand held by the patient or on the bed of the patient while the patient is bedridden;
displacing the air flow through the housing into a proximal end of a directional air conduit located directly above the bed;
under control of the patient while on the bed, selectively positioning a discharge end of the air conduit and issuing a stream of effluent air from the air conduit at a location above the bed onto any desired body location of the patient.

27. A method according to claim 26 wherein a fan within the hand held housing is powered by electricity from a source selected from the group consisting of a battery and a wall outlet.

28. A method according to claim 26 comprising the act of patient locating the housing so that the housing rests on the bed.

29. A method according to claim 26 further comprising the act of patient relocating of the distal end of the air conduit so that the air conduit remains above the bed but the effluent stream of air is directed to successive patient body locations.

30. A method according to claim 26 comprising the further act of changing by action of the patient the length of the air conduit.

31. A method according to claim 26 comprising the further act of reconfiguring by the patient of the air conduit in any one of several non-linear configurations.

32. A method according to claim 26 wherein the positioning act comprises extending the length and modifying the configuration by the patient of the air conduit to accommodate successive discharge of air upon different patient locations.

33. A method according to claim 26 comprising the act of delivering low voltage electrical power to a motor by which a fan is rotated within the handheld housing.

34. A method according to claim 26 wherein the housing comprises a cylindrical external configuration sized to be held within the hand of the patient and safely placed upon the bed next to the patient.

35. A method by which a bedridden medical patient self-applies a stream of air directly to any desired body location comprising the acts of:
creating influent air flow into and through a housing directly above the bed under the control of the patient while the patient is bedridden;
displacing the air flow from a distal end of the housing into a proximal end of a directional air conduit located directly above the bed;
under control of the patient while the patient is bedridden, selectively positioning a distal discharge end of the air conduit and issuing a stream of effluent air from the distal end of the air conduit, at location above the bed, onto any desired body location of the patient.

36. A method according to claim 35 wherein the location of the housing during the creating, displacing and positioning acts is selected from the group comprising: (a) hand held by the patient; (b) on the bed; and (c) a combination of (a) and (b).

37. An apparatus for selective application by a bedridden medical patient of a stream of air to a desired body area to improve patient comfort comprising:
a hollow housing sized to be held in the hand of the patient and placed upon the bed occupied by the patient, the housing having an influent opening and a discharge site both disposed above the bed under the control of the patient during use of the apparatus;
a fan concealed within the housing,
a motor concealed within the housing by which, under the control of the patient, the fan is rotated to displace influent air from above the bed into the influent opening and through the hollow of the housing;
a hollow tube connected to the discharge site of the housing to receive above the bed from the housing air being displaced through the housing by the fan, the hollow tube comprising a distal end under the control of the patient above the bed comprising an effluent opening by which the patient directs a stream of air issuing therefrom to impinge upon selected areas of the body as selected by the patient.

38. An apparatus according to claim 37 further comprising a low voltage battery by which the motor is rotated.

39. An apparatus according to claim 37 further comprising a transformer by which electricity is transformed into low voltage electricity by which the motor is rotated.

40. An apparatus according to claim 37 wherein the fan comprises yieldable radially-extending blades formed of synthetic resinous material.

41. An apparatus according to claim 37 further comprising a sheath within the housing circumferentially surrounding and supporting the motor and the fan therein.

42. An apparatus according to claim 37 wherein a drive shaft rotatably connects the fan and the motor and is concealed within the housing.

43. An apparatus according to claim 37 wherein a porous cover is disposed at the influent opening.

44. An apparatus according to claim 37 wherein the housing is of a cylindrical configuration.

45. An apparatus according to claim 37 wherein the hollow tube comprises a variable length for selective adjustment by the patient above the bed to customize impingement of the stream of effluent air upon selected body areas of the patient.

46. An apparatus according to claim 37 wherein the hollow tube is yieldable accommodating variation by the patient above the bed in configurations of the tube to customize the impingement of the stream of effluent air upon selected body areas of the patient.

47. An apparatus according to claim 37 wherein the hollow tube comprises a yeildable tube of variable length accommodating a variety of patient-created configurations to customize impingement above the bed of the stream of effluent air upon selected body areas of the patient.
